(19) United States
(12) Patent Application Publication
(10) Pub. No.: US 2012/0120026 A1
(43) Pub. Date: May 17, 2012

(54) OPTICAL TOUCH DEVICE AND LIGHT SENSING MODULE THEREOF

(75) Inventor: HUI-HSUAN CHEN, Hsinchu (TW)

(73) Assignee: PixArt Imaging Inc., Hsinchu (TW)

(21) Appl. No.: 13/186,959

(22) Filed: Jul. 20, 2011

Related U.S. Application Data
(63) Continuation-in-part of application No. 12/947,280, filed on Nov. 16, 2010.

(30) Foreign Application Priority Data
Apr. 13, 2011 (TW) 100112810

(51) Int. Cl. G06F 3/042; H01J 40/14

(52) U.S. Cl. 345/175; 250/221

(57) ABSTRACT

An optical touch device includes at least a light sensing module disposed beside the touch area. The light sensing module includes a sensing unit, a lens component and at least a reflecting member and. The sensing unit has a plurality of sensing regions. Each of the sensing regions has a field of view. The at least a reflecting member is disposed in the front of at least one of the sensing regions to turn the field of view of the corresponding sensing region. The lens component includes a first substrate and a plurality of lenses. The first substrate is disposed between the at least a reflecting member and the sensing unit. The lenses are assembled with the first substrate and respectively disposed in the front of the sensing regions. The optical touch device is adapted to be applied to an electronic product. Moreover, two light sensing modules are provided.

### CROSS REFERENCE TO RELATED APPLICATIONS

This application is a continuation in part of U.S. application Ser. No. 12/947,280 filed on Nov. 16, 2010. The entirety of the above-mentioned patent are hereby incorporated by reference herein and made a part of this specification.

### FIELD OF THE INVENTION

The present invention relates to a touch device, and more particularly to an optical touch device and a light sensing module thereof.

### BACKGROUND OF THE INVENTION

A touch device has an advantage of easy operation. Recently, the touch device has been widely applied to various electronic products, for example, mobile telephones, personal digital assistants (PDAs), digital cameras, music players, computers, satellite navigation devices, touch screens, and so on. Generally, a familiar type of the touch device is, for example, a resistive touch device, a capacitive touch device or an optical touch device. The optical touch device has a lower cost comparative to the resistive touch device or the capacitive touch device.

FIG. 1 is a schematic view of a conventional optical touch device applied to a touch display device. Referring to FIG. 1, the conventional optical touch device includes two sensing chips 50. The two sensing chips 50 are respectively disposed at two corners of a display panel 60 and at two ends of a side 62 of the display panel 60. Each of the two sensing chips 50 has a sensing surface 52. An included angle θ between a normal vector 53 of the sensing surface 52 and the side 62 of the display panel 60 is 45 degrees. In addition, each of the two sensing chips 50 has a field of view 54. The two fields of view 54 of the two sensing chips 50 are partially overlapped and cover a touch surface 64 of the display panel 60 entirely so as to sense a location of a touch member (e.g., a finger, a pen, etc.) on the touch surface 64.

Nowadays, the electronic products including the touch display devices have a developing trend of miniaturization. To miniaturize the electronic product, it is very critical to dispose various components of the electronic product in a limited space in a better manner. However, because the two sensing chips 50 of the conventional optical touch device are disposed at two corners of the display panel 60, the angles of disposing the sensing chips 50 are limited. In other words, the components of the conventional touch display device can not be disposed flexibly. Thus, the volume of the conventional touch display device can not be reduced effectively.

### SUMMARY OF THE INVENTION

The present invention provides an optical touch device, and the location and the angle of disposing the optical touch device are flexible.

The present invention also provides a light sensing module, and a sensing unit of the light sensing module includes two sensing regions so that the location and the angle of disposing the light sensing module are flexible.

The present invention further provides a light sensing module, and a sensing unit of the light sensing module includes three sensing regions so that the location and the angle of disposing the light sensing module are flexible.

To achieve at least of one the above-mentioned advantages, the present invention provides an optical touch device having a touch area. The optical touch device includes at least a light sensing module disposed beside the touch area. The light sensing module includes a sensing unit, a lens component and at least a reflecting member and. The sensing unit has a plurality of sensing regions. Each of the sensing regions has a field of view. The at least a reflecting member is disposed in the front of at least one of the sensing regions so as to turn the field of view of the corresponding sensing region. The lens component is located in the front of the sensing unit and includes a first substrate and a plurality of lenses. The first substrate is disposed between the at least a reflecting member and the sensing unit. The lenses are assembled with the first substrate and respectively disposed in the front of the sensing regions.

In one embodiment provided by the present invention, a material of the lenses is different from a material of the first substrate.

In one embodiment provided by the present invention, the first substrate is either a glass substrate or a quartz substrate, and the material of the lenses is either epoxy resin or silicon resin.

In one embodiment provided by the present invention, the lens component is a wafer level lens.

In one embodiment provided by the present invention, a material of the lenses is identical to a material of the first substrate.

In one embodiment provided by the present invention, the material of the lenses and the material of the first substrate comprise plastic.

In one embodiment provided by the present invention, the light sensing module further includes a second substrate, and the at least a reflecting member is assembled with the second substrate.

In one embodiment provided by the present invention, a material of the first substrate is identical to a material of the second substrate, and a material of the at least a reflecting member is identical to a material of the lenses.

In one embodiment provided by the present invention, the second substrate and the at least a reflecting member are formed by using a wafer level lens technology.

To achieve at least of one the above-mentioned advantages, the present invention also provides a light sensing module of an optical touch device. The light sensing module includes a sensing unit, a reflecting member and a lens component. The sensing unit has a first sensing region and a second sensing region. Each of the first sensing region and the second sensing region has a field of view. The reflecting member is disposed in the front of the first sensing region so as to turn the field of view of the first sensing region. The lens component is located in the front of the sensing unit and includes a first substrate and a plurality of lenses. The first substrate is disposed between the at least a reflecting member and the sensing unit. The lenses are assembled with the first substrate and respectively disposed in the front of the first sensing region and the second sensing region.

In one embodiment provided by the present invention, the sensing unit further includes a second substrate, and the reflecting member is assembled with the second substrate.

In one embodiment provided by the present invention, the second substrate and the reflecting member are formed by using a wafer level lens technology.

In one embodiment provided by the present invention, the lens component is a wafer level lens.

To achieve at least of one the above-mentioned advantages, the present invention further provides a light sensing module of an optical touch device. The light sensing module includes a sensing unit, a first reflecting member, a second reflecting member, a lens component and a second substrate. The sensing unit has a first sensing region, a second sensing region and a third sensing region. Each of the first sensing region, the second sensing region and the third sensing region has a field of view. The first reflecting member is disposed in the front of the first sensing region so as to turn the field of view of the first sensing region. The second reflecting member is disposed in the front of the third sensing region so as to turn the field of view of the third sensing region. The lens component is located in the front of the sensing unit and includes a first substrate and a plurality of lenses. The lenses are assembled with the first substrate and respectively disposed in the front of the first sensing region, the second sensing region and third sensing region. The first substrate is disposed between the second substrate and the sensing unit. The first reflecting member and the second reflecting member are assembled with the second substrate.

In one embodiment provided by the present invention, the lens component is a wafer level lens.

In one embodiment provided by the present invention, the second substrate, the first reflecting member and the second reflecting member are formed by using a wafer level lens technology.

In the optical touch device of one embodiment of the present invention, the light sensing module includes at least a reflecting member disposed in the front of at least one of the sensing regions so as to turn the field of view of the corresponding sensing region. Thus, the location and the angle of disposing the light sensing module are flexible. Additionally, in the optical touch device of another two embodiments of the present invention, the light sensing module includes a plurality of sensing regions. A reflecting member is disposed in the front of at least one of sensing regions so as to turn the field of view of the corresponding sensing region. Thus, the location and the angle of disposing the light sensing module are flexible.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a schematic view of a conventional optical touch device applied to a touch display device.

FIG. 2 is a schematic view of an optical touch device in accordance with an embodiment of the present invention.

FIG. 3 is a schematic view of an optical touch device in accordance with another embodiment of the present invention.

FIG. 4 is a schematic view of a light sensing module in accordance with another embodiment of the present invention.

FIG. 5 is a schematic view of a light sensing module in accordance with still another embodiment of the present invention.

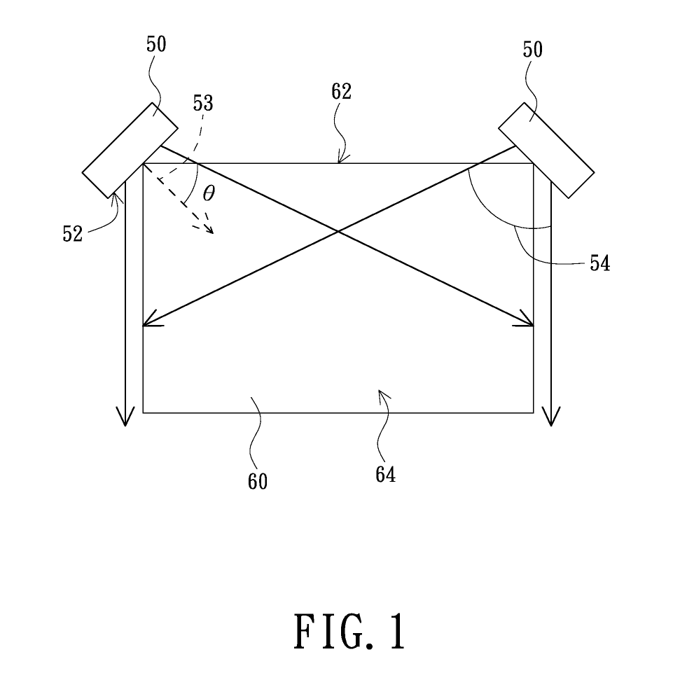

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

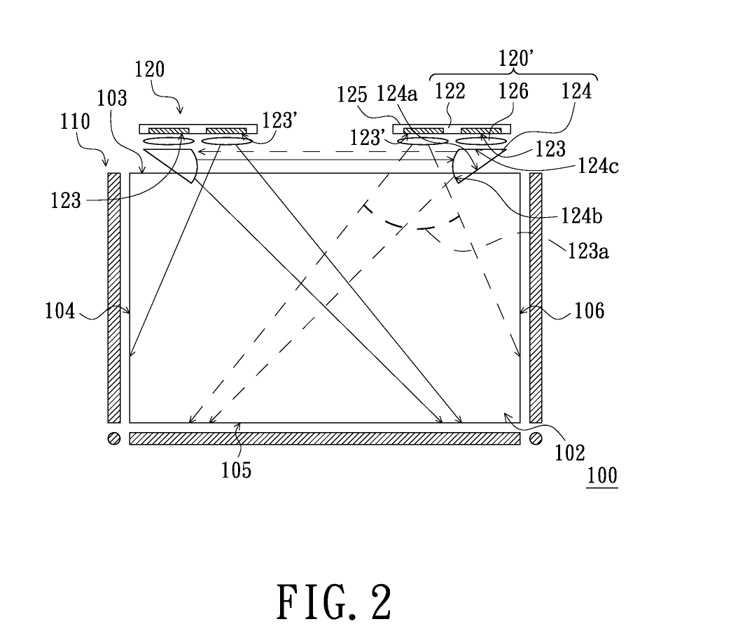

FIG. 2 is a schematic view of an optical touch device in accordance with an embodiment of the present invention. Referring to FIG. 2, in the present embodiment, an optical touch device 100 has a touch area 102. The optical touch device 100 includes at least a light sensing module. In the present embodiment, as shown in FIG. 2, the optical touch device 100 includes, for example, two light sensing modules 120, 120′. The first sensing module 120 is a first light sensing module, and the second sensing module 120′ is a second light sensing module. Each of the two light sensing modules 120, 120′ includes a sensing unit 122 and at least a reflecting member 124. For example, only one reflecting member 124 is shown in FIG. 2. The sensing unit 122 has a plurality of sensing regions. In the present embodiment, as shown in FIG. 2, the sensing unit 122 includes, for example, two sensing regions 123, 123′. The sensing region 123 is a first sensing region, and the sensing region 123′ is a second sensing region. Each of the two sensing regions 123, 123′ has a field of view 123a. The fields of view 123a of the two adjacent sensing regions 123, 123′ of the sensing unit 122 are, for example, partially overlapped. Additionally, the reflecting member 124 is disposed in the front of at least one of the sensing regions 123, 123′. In the present embodiment, the reflecting member 124 is disposed in the front of the sensing region 123 so as to turn the field of view 123a of the corresponding sensing region 123.

In detail, the touch area 102 is, for example, rectangular, and has a first side 103, a second side 104, a third side 105 and a fourth side 106. The first side 103 faces to the third side 105, and the second side 104 faces to the fourth side 106. The light sensing modules 120, 120′ are disposed beside the first side 103. The light sensing module 120 is near to the second side 104, and the light sensing module 120′ is near to the fourth side 106. In addition, the sensing regions 123, 123′ of the sensing unit 122 of each of the light sensing modules 120, 120′ face to the touch area 102. In the light sensing module 120, the sensing region 123 is nearer to the second side 104 than the sensing region 123′. The reflecting member 124 in the front of the sensing region 123 of the light sensing module 120 is configured for turning the field of view 123a of the sensing region 123 of the light sensing module 120 towards the fourth side 106. In the light sensing module 120′, the sensing region 123 is nearer to the fourth side 106 than the sensing region 123′. The reflecting member 124 in the front of the sensing region 123 of the light sensing module 120′ is configured for turning the field of view 123a of the sensing region 123 of the light sensing module 120′ towards the second side 104. Additionally, the sensing regions 123, 123′ of the light sensing modules 120, 120′ totally cover the touch area 102.

The sensing unit 122 is, for example, a sensing chip. The sensing unit 122 includes a substrate 125. The sensing regions 123, 123′ are disposed on the substrate 125. In the present embodiment, each of the sensing regions 123, 123′ of the sensing unit 122 is an individual sensing region of the sensing chip. In another embodiment, the sensing unit 122 is, for example, a sensing chip. The sensing regions 123, 123′ of the sensing unit 122 are sub-regions divided from a sensing region of the sensing chip. In still another embodiment, the sensing unit 122 can further includes a plurality of sensing chips. Each of the sensing chips includes one of the sensing regions 123, 123′. Additionally, the sensing unit 122 and the reflecting member 124 can be two separated components, or be put in a package together.

In the present embodiment, the reflecting member 124 is, for example, a prism. The prism includes a reflecting surface 124a, a light incidence surface 124b and a light emitting surface 124c. The light emitting surface 124c faces to the sensing region 123, and is connected between the reflecting surface 124a and the light incidence surface 124b. The light incidence surface 124b can be a convex curved surface so as to enlarge the field of view 123a of the sensing region 123. In addition, each of the light sensing modules 120, 120′ can further include a plurality of lenses 126. The lenses 126 are respectively disposed in the front of the sensing regions 123, 123′ so as to enlarge the fields of view 123a of the sensing regions 123, 123′. The number of the lenses 126 in the front of the sensing regions 123, 123′ is not limited by the embodiment of the present invention. Additionally, in the present embodiment, the optical touch device 100 further includes, for example, at least an infrared light source module 110 for providing optical signals to the touch area 102. In FIG. 2, three infrared light source modules 110 are taken as an example, and the three infrared light source modules 110 are respectively disposed beside the second side 104, the third side 105 and the fourth side 106 of the touch area 102.

In the optical touch device 100 of the present embodiment, the reflecting member 124 disposed in the front of the sensing region 123 is configured for turning the field of view 123a of the sensing region 123. Thus, the location and the angle of disposing the sensing unit 122 are not limited. In other words, in the present embodiment, the location and the angle of disposing the sensing unit 122 of the optical touch device 100 are flexible. Thus, an available mechanical space of an electronic product is not limited during designing the electronic product. Therefore, the optical touch device 100 in the present embodiment is easily applied to the electronic products having a limited inner space and further benefits reducing the volume of the electronic product.

It should be noted that the location and the angle of disposing the light sensing module 120/120′ in the present embodiment are examples, which can be adjusted according to the demand. An included angle between the reflecting surface 124a and the light emitting surface 124c of the reflecting member 124 can also be adjusted according to the demand. Thus, the location and the angle of disposing the light sensing modules 120/120′ can further be flexible. In addition, although the exemplary two light sensing modules 120, 120′ are described in the present embodiment, the optical touch device in another embodiment can include either only one light sensing module or more than two light sensing modules. Additionally, the infrared light source modules 110 can be disposed around the touch area 102.

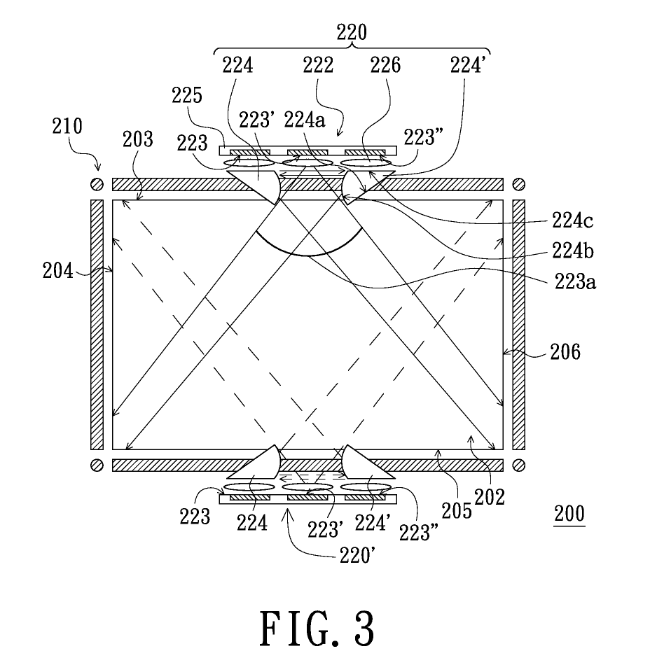

FIG. 3 is a schematic view of an optical touch device in accordance with another embodiment of the present invention. Referring to FIG. 3, an optical touch device 200 in the present embodiment is similar to the aforesaid optical touch device 100. The differences of the optical touch device 200 and the optical touch device 100 are described as follows. The optical touch device 200 includes two light sensing modules 220, 220′. The light sensing module 220 is a first light sensing module, and the light sensing module 220′ is a second light sensing module. The light sensing module 220 is disposed beside a first side 203 of a touch area 202, and the light sensing module 220′ is disposed beside a third side 205 of the touch area 202. The light sensing module 220 faces to the light sensing module 220′. Each of the light sensing modules 220, 220′ includes a sensing unit 222 and two reflecting members 224, 224′. The reflecting member 224 is a first reflecting member, and the reflecting member 224′ is a second reflecting member. In addition, the sensing unit 222 includes three sensing regions 223, 223′, 223″ facing to the touch area 202. The sensing region 223 is a first sensing region, the sensing region 223′ is a second sensing region, and the sensing region 223″ is a third sensing region. The sensing region 223′ is located between the sensing region 223 and the sensing region 223″. The sensing region 223 is nearer to a second side 204 of the touch area 202 than the sensing region 223′.

Each of the sensing regions 223, 223′, 223″ has a field of view 223a. The reflecting member 224 disposed in the front of the sensing region 223 is configured for turning the field of view 223a of the sensing region 223 towards the fourth side 206. The reflecting member 224′ disposed in the front of the sensing region 223″ is configured for turning the field of view 223a of the sensing region 223″ towards the second side 204. In addition, the fields of view 223a of the two adjacent sensing regions 223, 223′ are, for example, partially overlapped, and the fields of view 223a of the two adjacent sensing regions 223′, 223″ are also, for example, partially overlapped.

The sensing unit 222 is, for example, a sensing chip. The sensing unit 222 includes a substrate 225. The sensing regions 223, 223′, 223″ of the sensing unit 222 are disposed on the substrate 225. In the present embodiment, each of the sensing regions 223, 223′, 223″ of the sensing unit 222 is an individual sensing region of the sensing chip. In another embodiment, the sensing unit 222 is, for example, a single sensing chip. The sensing regions 223, 223′, 223″ of the sensing unit 222 are sub-regions divided from a sensing region of the single sensing chip. In still another embodiment, the sensing unit 222 can further includes a plurality of sensing chips. Each of the sensing chips includes one of the sensing regions 223, 223′, 223″. Additionally, the sensing unit 222 and the reflecting members 224′, 224″ can be three separated components, or be put in a package together.

In the present embodiment, each of the reflecting members 224, 224′ is, for example, a prism. The prism includes a reflecting surface 224a, a light incidence surface 224b and a light emitting surface 224c. The light incidence surface 224b is connected between the reflecting surface 224a and the light emitting surface 224c. The light emitting surface 224c of the reflecting member 224 faces to the touch area 223, and the light emitting surface 224c of the reflecting member 224′ faces to the touch area 223″. The light incidence surface 224b can be a convex curved surface so as to enlarge the field of view 223a of the sensing region 223/223″. In addition, each of the light sensing modules 220, 220′ can further include a plurality of lenses 226. The lenses 226 are respectively disposed in the front of the sensing regions 223, 223′, 223″ so as to enlarge the fields of view 223a of the sensing regions 223, 223′, 223″. The number of the lenses 226 in the front of the sensing regions 223, 223′, 223″ is not limited by the embodiment of the present invention. Additionally, in the present embodiment, the optical touch device 200 further includes, for example, at least an infrared light source module 210 for providing optical signals to the touch area 202. In FIG. 3, four infrared light source modules 210 are taken as an example, and the four infrared light source modules 210 are respectively disposed beside the first side 203, the second side 204, the third side 205 and the fourth side 206 of the touch area 202.

The advantages of the optical touch device 200 are similar to the advantages of the optical touch device 100 and are not described here. Additionally, in the present embodiment, the location and the angle of disposing the light sensing module 222 can be adjusted according to the demand. The optical touch device 200 can include either one the light sensing module or more than two light sensing modules.

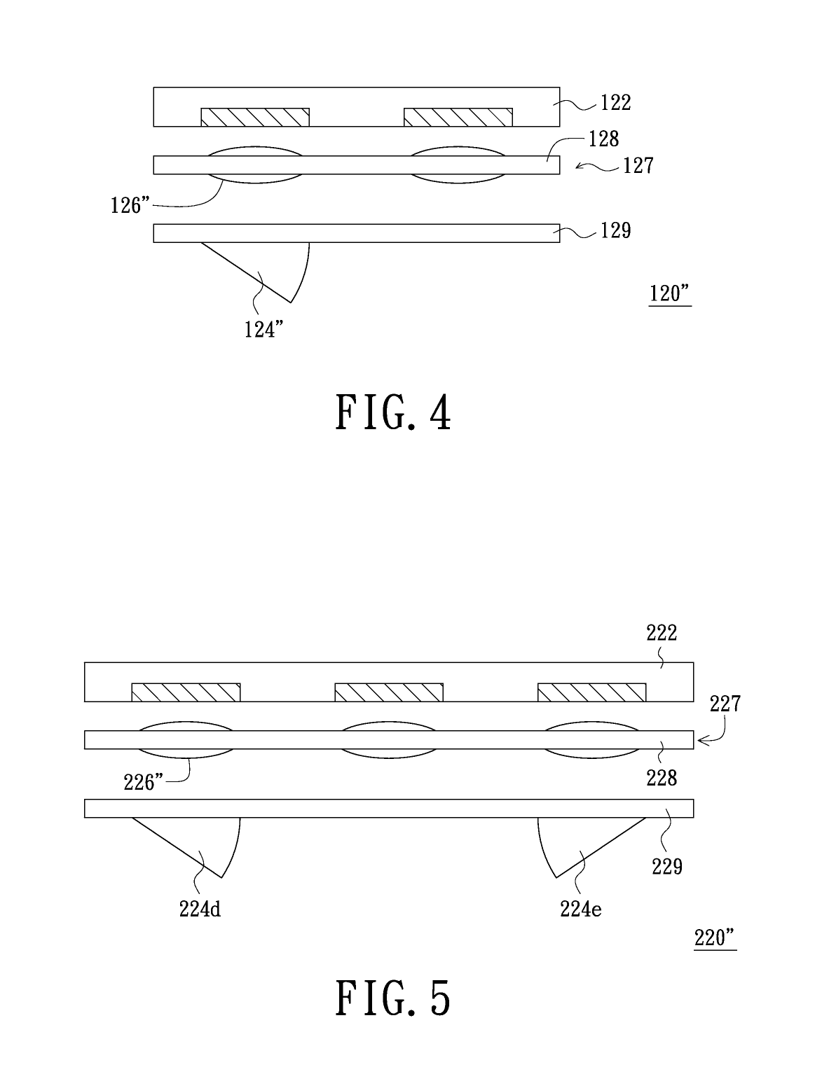

It is noted that, the lenses 126 of the light sensing module 120 and the light sensing module 120′ can be integrated into one lens component. FIG. 4 is a schematic view of a light sensing module in accordance with another embodiment of the present invention. Referring to FIG. 4, a light sensing module 120″ is similar to the light sensing module 120/120′ except a plurality of lenses 126″ integrated into a lens component 127. The light sensing module 120″ can replace the light sensing module 120/120′. The lens component 127 includes a first substrate 128 and the lenses 126″. The first substrate 128 is disposed between the sensing unit 122 and a reflecting member 124″. The lenses 126″ are assembled with the first substrate 128.

A material of the lenses 126″ of the lens component 127 can be different from a material of the first substrate 128. For example, when the lens component 127 is a wafer level lens formed by using a wafer level lens technology, the material of the lenses 126″ of the lens component 127 is different from the material of the first substrate 128. In detail, the first substrate 128 is, for example, a glass substrate or a quartz substrate, and the material of the lenses 126″ is, for example, epoxy resin, silicon resin or other light-cured materials.

Additionally, the material of the lenses 126″ of the lens component 127 can also be identical to the material of the first substrate 128. For example, when the lens component 127 is formed by using an injection molding technology, the material of the lenses 126″ of the lens component 127 is identical to the material of the first substrate 128. In detail, the material of the first substrate 128 and the lenses 126″ is, for example, plastic.

In the present embodiment, the light sensing module 120″ further includes a second substrate 129. The reflecting member 124″ is assembled with the second substrate 129. For example, a material of the second substrate 129 is identical to the material of the first substrate 128, and a material of the reflecting member 124″ is identical to the material of the lenses 126″. In other words, the material of the second substrate 129 can be different from the material of the reflecting member 124″. For example, the second substrate 129 can be either a glass substrate or a quartz substrate, and the material of the reflecting member 124″ can be epoxy resin, silicon resin or other light-cured materials. The second substrate 129 and the reflecting member 124″ can be formed by using the wafer level lens technology on the condition that the material of the second substrate 129 is different from the material of the reflecting member 124″. It is noted that, the material of the second substrate 129 can be identical to the material of the reflecting member 124″. For example, the material of the second substrate 129 and the reflecting member 124″ is, for example, plastic. The second substrate 129 and the reflecting member 124″ can be formed by using the injection molding technology on the condition that the material of the second substrate 129 is identical to the material of the reflecting member 124″. Further, another lens can also be assembled with the second substrate 129.

In the present embodiment, the reflecting member 124″ and the second substrate 129 of the light sensing module 120″ can be replaced by the reflecting member 124 shown in FIG. 2. That is, the second substrate 129 of the light sensing module 120″ can be omitted.

FIG. 5 is a schematic view of a light sensing module in accordance with still another embodiment of the present invention. Referring to FIG. 5, the light sensing module 220″ is similar to the light sensing module 220/220′ except a plurality of lenses 226″ integrated into a lens component 227. The light sensing module 220″ can replace the light sensing module 220/220′. The lens component 227 includes a first substrate 228 and the lenses 226″. The first substrate 228 is disposed between the sensing unit 222 and two reflecting members 224d, 224e. The lenses 226″ are assembled with the first substrate 228.

Similar to the lens component 127, in the present embodiment, a material of the lenses 226″ of the lens component 227 can be either different from or identical to a material of the first substrate 228. The lens component 227 is a wafer level lens formed by using the wafer level lens technology on the condition that the material of the lenses 226″ of the lens component 227 is different from the material of the first substrate 228. The lens component 227 can be formed by using the injection molding technology on the condition that the material of the first substrate 228 is identical to the lenses 226″. Further, the light sensing module 220″ can include a second substrate 229. The reflecting members 224d, 224e are assembled with the second substrate 229. For example, a material of the second substrate 229 is identical to the material of the first substrate 228, and a material of the reflecting members 224d, 224e is identical to the material of the lenses 226″. In other words, the material of the second substrate 229 can be either different from or identical to the material of the reflecting members 224d, 224e. The second substrate 229 and the reflecting members 224d, 224e can be formed by using the injection molding technology on the condition that the material of the second substrate 229 is identical to the material of the reflecting members 224d, 224e. The second substrate 229 and the reflecting members 224d, 224e can be formed by using the wafer level lens technology on the condition that the material of the second substrate 229 is different from the material of the reflecting members 224d, 224e. Further, another lens can also be assembled with the second substrate 229. In the present embodiment, the reflecting members 224d, 224e and the second substrate 229 of the light sensing module 220″ can be replaced by the reflecting members 224, 224′ shown in FIG. 3. That is, the second substrate 229 of the light sensing module 220″ can be omitted.

In summary, the optical touch device and the light sensing module of the present invention has at least the following advantages:

1. The light sensing module includes the sensing regions and the reflecting member is disposed in the front of at least one of the sensing regions so as to turn the field of view of the corresponding sensing region. Thus, the location and the angle of disposing the light sensing module are flexible.

2. Because the location and the angle of disposing the light sensing module of the optical touch device are flexible, the optical touch device is easily applied to the electronic product having a limited inner space and further benefits reducing the volume of the electronic product.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An optical touch device having a touch area, comprising:
at least a light sensing module disposed beside the touch area, and the light sensing module comprising:
a sensing unit having a plurality of sensing regions, and each of the sensing regions having a field of view;
at least a reflecting member disposed in the front of at least one of the sensing regions to turn the field of view of the corresponding sensing region; and
a lens component in the front of the sensing unit, the lens component comprising a first substrate and a plurality of lenses, the first substrate being disposed between the at least a reflecting member and the sensing unit, and the lenses being assembled with the first substrate and respectively disposed in the front of the sensing regions.

2. The optical touch device as claimed in claim 1, wherein a material of the lenses is different from a material of the first substrate.

3. The optical touch device as claimed in claim 2, wherein the first substrate is either a glass substrate or a quartz substrate, and the material of the lenses is either epoxy resin or silicon resin.

4. The optical touch device as claimed in claim 2, wherein the lens component is a wafer level lens.

5. The optical touch device as claimed in claim 1, wherein a material of the lenses is identical to a material of the first substrate.

6. The optical touch device as claimed in claim 5, wherein the material of the lenses and the material of the first substrate comprise plastic.

7. The optical touch device as claimed in claim 1, wherein the light sensing module further comprises a second substrate, and the at least a reflecting member is assembled with the second substrate.

8. The optical touch device as claimed in claim 7, wherein a material of the first substrate is identical to a material of the second substrate, and a material of the at least a reflecting member is identical to a material of the lenses.

9. The optical touch device as claimed in claim 7, wherein the second substrate and the at least a reflecting member are formed by using a wafer level lens technology.

10. A light sensing module for an optical touch device, comprising:
a sensing unit having a first sensing region and a second sensing region, and each of the first sensing region and the second sensing region having a field of view; and
a reflecting member disposed in the front of the first sensing region to turn the field of view of the first sensing region; and
a lens component in the front of the sensing unit, the lens component comprising a first substrate and a plurality of lenses, the first substrate being disposed between the at least a reflecting member and the sensing unit, and the lenses being assembled with the first substrate and respectively disposed in the front of the first sensing region and the second sensing region.

11. The light sensing module as claimed in claim 10, wherein the sensing unit further comprises a second substrate, and the reflecting member is assembled with the second substrate.

12. The light sensing module as claimed in claim 11, wherein the second substrate and the reflecting member are formed by using a wafer level lens technology.

13. The light sensing module as claimed in claim 10, wherein the lens component is a wafer level lens.

14. A light sensing module for an optical touch device, comprising:
a sensing unit having a first sensing region, a second sensing region and a third sensing region, and each of the first sensing region, the second sensing region and the third sensing region having a field of view;
a first reflecting member disposed in the front of the first sensing region to turn the field of view of the first sensing region; and
a second reflecting member disposed in the front of the third sensing region to turn the field of view of the third sensing region;
a lens component in the front of the sensing unit, the lens component comprising a first substrate and a plurality of lenses, and the lenses being assembled with the first substrate and respectively disposed in the front of the first sensing region, the second sensing region and third sensing region; and
a second substrate, the first substrate being disposed between the second substrate and the sensing unit, and the first reflecting member and the second reflecting member being assembled with the second substrate.

15. The light sensing module as claimed in claim 14, wherein the lens component is a wafer level lens.

16. The light sensing module as claimed in claim 14, wherein the second substrate, the first reflecting member and the second reflecting member are formed by using a wafer level lens technology.
